(19) United States
(12) Patent Application Publication
(10) Pub. No.: US 2011/0231940 A1
(43) Pub. Date: Sep. 22, 2011

(54) CREDENTIAL-BASED ACCESS TO DATA

(75) Inventors: Raja Pazhanivel Perumal, Issaquah, WA (US); Jeffrey B. Hamblin, Issaquah, WA (US)

(73) Assignee: MICROSOFT CORPORATION, Redmond, WA (US)

(21) Appl. No.: 12/727,763

(22) Filed: Mar. 19, 2010

(51) Int. Cl. G06F 21/24; G06F 17/30

(52) U.S. Cl. 726/28

(57) ABSTRACT

Existing mechanisms that control access to data based upon whether the user seeking to access the data is identified among the users that are allowed to access the data, can be extended to further control access based upon the provision of credential data by the user, or processes associated therewith. Access control entries can limit access based upon Boolean conditionals, including those referencing credential data, such that access can be granted only to specific users that provide the credential data or, alternatively, to any user that provides it. The referenced credential data can be specified in the access control information in an obfuscated form for security purposes. Information associated with the user, such as a user token, can be temporarily updated to include credential data when provided by the user, so as to enable access to the data but to prevent such access from remaining open too long.

### BACKGROUND

The security of computer-readable data is most commonly implemented by gate-keeping mechanisms that enable authorized users or, more accurately, processes acting on behalf of such users, to access computer-readable data while simultaneously preventing unauthorized users, and their associated processes, from accessing the data. One such gate-keeping mechanism is the encryption of data coupled with the provision of information necessary to decrypt, and subsequently access, the data to only those users that are authorized to access such data. Such a gate-keeping mechanism is traditionally provided by specialized computer-executable instructions, such as an encryption application program, where users who seek to access such data would need to have that encryption application program, or an analog thereof, in order to decrypt, and subsequently access, the data.

The operating systems utilized by computing devices can also implement a gate-keeping mechanism through the use of access controls that limit a user's access to data based upon a comparison between that user and a list of users, or user groups, that are authorized to access the data. Traditionally, such operating systems require a user to log on, such as by entering a user name and a password. Once a user has logged on to such an operating system, a collection of data identifying the user, often referred to as a “user token” is generated on behalf of, and associated with, the user. Whenever the user, or an application acting on behalf of the user, attempts to access some data, an access control list associated with the data being accessed is referenced. A calculation is then performed with the authorization data in the access control list and the identity data in the user token, indicating the ability of the logged-on user to access the data. If the access control list associated with the data that is being accessed does not somehow indicate that the logged-on user is authorized to access the data, the access request is failed by the operating system.

Unfortunately, in many environments, the actual human user interacting with a computing device and its operating system is not the same as the user identified in the token that was generated. For example, many families utilize a single logon such that the same user token is generated irrespective of which member of such a family is actually utilizing the computing device. As another example, one user's username and password may be stolen by, and subsequently utilized by, another, different, user. In such cases, because the access control implemented by the operating system is based upon the user token, human users that were never intended to be granted access to certain collections of data may, nevertheless, have access to those collections of data by virtue of being logged-on to the computing device as someone else. While dedicated utilities, such as application programs directed to the encryption of data, can protect sensitive information even if the human user utilizing the computing device is, in essence, tending to be someone else, such dedicated utilities require that every computing device that may ultimately need to access the protected data have installed thereon the dedicated utilities. In some situations, the number of such dedicated utilities installed on a given computing device may even be greater than the number of applications utilized to generate the data in the first place.

### SUMMARY

In one embodiment, existing access control mechanisms, such as within an operating system, can be modified to provide for access to specific collections of data based not only on information associated with the user currently logged-on to the computing device, but also based on the provision, by such a user, of appropriate credential data. The credential data can be as simple as a password or passphrase entered by, or on behalf of, the user. The credential data can also be a fingerprint, retinal scan, voice print, smartcard, or other like unique data that can be gathered from, or provided by, the user.

In another embodiment, access control information associated with a set of data to which access is to be limited in accordance with the access control information can comprise credential data such that access to the associated set of data can be limited based on the existence of, or the provision of, the credential data stored with the access control information. For security purposes, the credential data can be stored in an obfuscated form, such as by being hashed via one or more known hashing algorithms.

In a further embodiment, access control information associated with a set of data can comprise one or more Boolean conditionals, including Boolean conditionals based on the provision of the credential data, to enumerate a set of requirements under which access to the set of data can be granted. Thus, the provision of the credential data can be only one element required to gain access to the set of data.

In a still further embodiment, credential data can be stored as part of the user token, or other information collection associated with the user, only for sufficiently long as would be required to gain access to a particular set of protected data. The amount of time during which the credential data can be stored as part of the user token can be specified by an application program providing the credential data to the user token, or by the operating system itself.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary access control implemented by an exemplary operating system;

FIG. 2 is a block diagram of an exemplary computing device;

FIG. 3 is a block diagram of an exemplary enumeration of the specification of credential data for gaining access to a particular set of data;

FIG. 4 is a block diagram of an exemplary mechanism for accessing a set of data that requires the provision of credential data to gain access;

FIG. 5 is a flow diagram of an exemplary mechanism for providing access to a set of data; and

FIG. 6 is a flow diagram of an exemplary mechanism for accessing data and requesting credential data.

### DETAILED DESCRIPTION

The following description relates to the extension of access control mechanisms to enable access to data to be conditioned upon, and controlled by, the provision of pre-specified credential data. Access control information associated with a collection of data to which access is to be controlled can specify credential data that is to be provided prior to access being granted to such a collection of data. A user token, or other information associated with a user, can comprise credential data obtained from the user, such as through a common interface that can be utilized by any application acting on behalf of the user, or through a secure channel to the user that can be implemented by the operating system, such as a “secure desktop” interface. When a process acting on behalf of a user attempts to access a collection of data to which access is controlled, and for which credential data must be provided prior to access being granted, the user token can be referenced for the credential data. If the user token does not comprise the required credentials data, the user can be prompted to enter such data and the access can be reattempted. For security purposes, credential data can be stored an obfuscated form, such as a hashed form, in the access control information and, optionally, in the user token itself.

For purposes of illustration, the techniques described herein make reference to specific data structures, including, in particular, a “user token”, an “access control entry” and an “access control list”. Such references are strictly exemplary and are not intended to limit the mechanisms described to the specific examples provided. Indeed, the techniques described are applicable to any collections of data that comprise the relevant information, irrespective of the specific implementation. Thus, as utilized herein, the term “user token” means any collection of information that is uniquely associated with a user, as identified through a logon or similar procedure, that is generated when such a user is identified, again, such as through a logon or similar procedure. Similarly, as utilized herein, the term “access control entry” means any collection of information that is associated with a set of data to which access is to be controlled, and that specifies one or more criteria by which one or more types of access to the associated set of data are to be either granted or denied; and the term “access control list”, as utilized herein, means any collection of one or more such access control entries.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

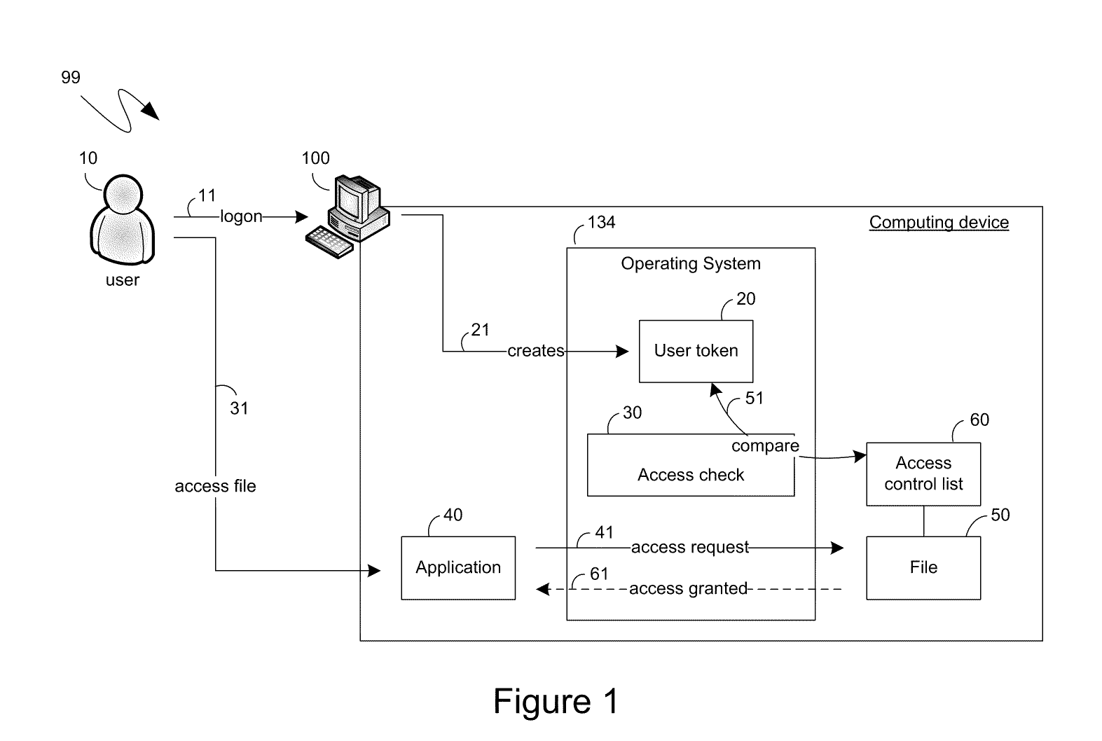

Turning to FIG. 1, the system 99 illustrated therein shows a simplified, exemplary set of communications and actions by which a modern operating system, such as the operating system 134 shown in FIG. 1, can control access to a given set of data. In particular, as illustrated by the system 99, a user 10 can perform a logon action 11 to log on to the computing device 100. Typically, as will be known by those skilled in the art, the logon action 11 by the user 10 can cause the operating system 134 to generate a user token 20, as illustrated by the action 21. As indicated previously, the user token 20 can comprise information associated with the user 10 that is unique to that user. Thus, for example, the user token 20 can comprise a unique identifier of the user 10. As another example, the user token 20 can comprise a listing of one or more groups of users, commonly referred to as “user groups”, to which the user 10 belongs.

At some point in time subsequent to the logon action 11, the user 10 can, either directly or indirectly, instruct an application 40, or other collection of processes executing on the computing device 100, to access a file or other collection of data, such as by the access action 31 illustrated in the system 99 of FIG. 1. In response to the access action 31, the application 40 can attempt to access the indicated data. For example, as illustrated by the system 99 of FIG. 1, the application 40 can make an access request 41 to the operating system 134 requesting that the operating system provides the application with access to a file, such as the file 50. Prior to granting the application 40 access to the file 50, the operating system 134 can compare the information in the user token 20 to the entries of an access control list 60 associated with the file 50 to which the access request was directed. Typically, such a compare operation 51 would be performed by an access check process or mechanism 30 that is executed as part of the operating system 134. Thus, while both the file 50 and the associated access control list 60 are shown as being “outside” of the operating system 134, such placement is only meant to illustrate that the data of the file 50 and the access control list 60 can be thought of as entities independent of the operating system 134. As described above, an as will be described in further detail below, the access control list 60 is managed by, and referenced by, processes that can be part of the operating system 134. Additionally, though not specifically relevant to the disclosures provided herein, the file 50 can, in some file system embodiments, be, likewise, managed by processes that can be part of the operating system 134. Nevertheless, the file 50 and access control list 60 will be illustrated separately from the operating system 134 to signify that they are not wholly operating system components or constructs.

Returning back to FIG. 1, if the access check 30 determines, such as via the compare action 51, that the user 10 is allowed to access the file 50, the operating system 134 can grant access to the file to the application 40 executing on the user's behalf. Alternatively, if the access check 30 determines that the user 10 is not allowed to access the file 50, the operating system 134 can deny the access request 41 from the application 40. Consequently, the access granted action 61 is shown in FIG. 1 via a dashed line to signify its conditional status.

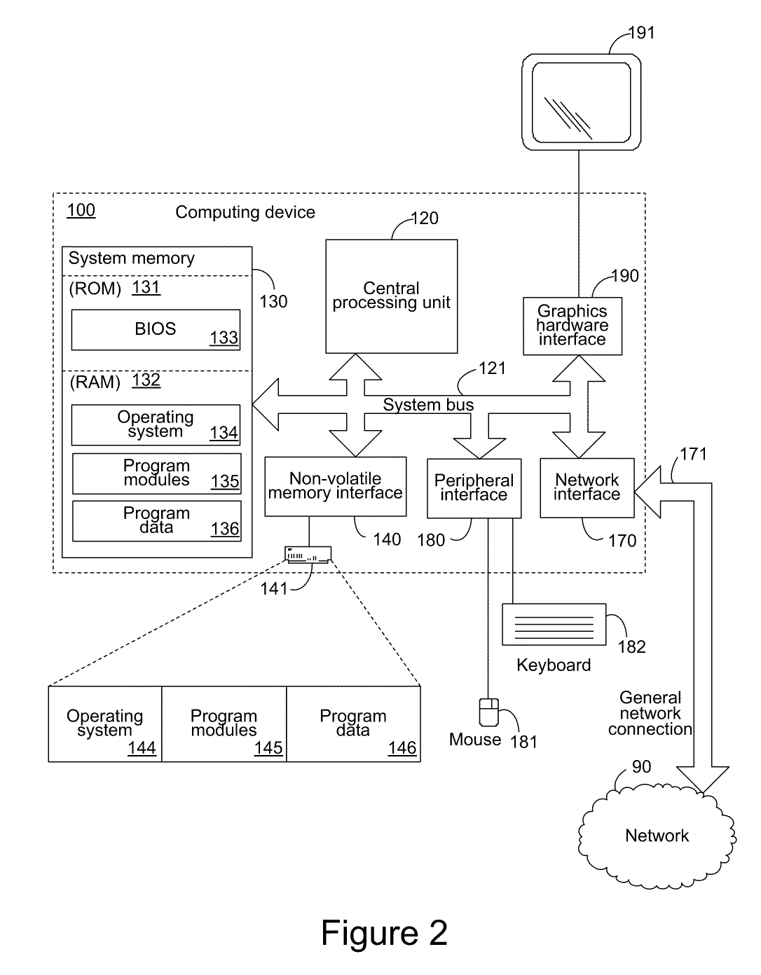

Turning to FIG. 2, the exemplary computing device 100 of the system 99 of FIG. 1 is illustrated and described in further detail. The exemplary computing device 100 shown in FIG. 2 can include, but is not limited to, one or more central processing units (CPUs) 120, a system memory 130, that can include RAM 132, and a system bus 121 that couples various system components including the system memory to the processing unit 120. The system bus 121 may be any of several types of bus structures including a memory bus or memory controller, a peripheral bus, and a local bus using any of a variety of bus architectures. The computing device 100 can optionally include graphics hardware, such as for the display of visual user interfaces, including, but not limited to, a graphics hardware interface 190 and a display device 191. Additionally, the computing device 100 can also include user interface elements, including, but not limited to a mouse 181 and a keyboard 182 that can be utilized by a user to generate input in response to the interface displayed via the display device 191. The user interface elements can be communicationally coupled to the system bus 121 via a peripheral interface 180 and use of the user interface elements by the user for the purposes of providing user input can generate signals that can be carried by the system bus 121 to computer-executable instructions executing as part of the operating system 134 which can, in turn, provide such user input to the operating system 134 or program modules 135, as appropriate.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and the aforementioned RAM 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates the operating system 134 along with other program modules 135, and program data 136.

The computing device 100 may also include other removable/non-removable, volatile/nonvolatile computer storage media. By way of example only, FIG. 2 illustrates the hard disk drive 141 that reads from or writes to non-removable, non-volatile magnetic media. Other removable/non-removable, volatile/non-volatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing operating system 144, other program modules 145, and program data 146, the latter two which can include some or all of the exemplary application 40 illustrated in FIG. 1 and described in more detail below. Note that components 144, 145 and 146 can either be the same as or different from operating system 134, other program modules 135 and program data 136. Operating system 144, other program modules 145 and program data 146 are given different numbers hereto illustrate that, at a minimum, they are different copies.

The computing device 100 can operate in a networked environment using logical connections to one or more remote computers. The computing device 100 is illustrated as being connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

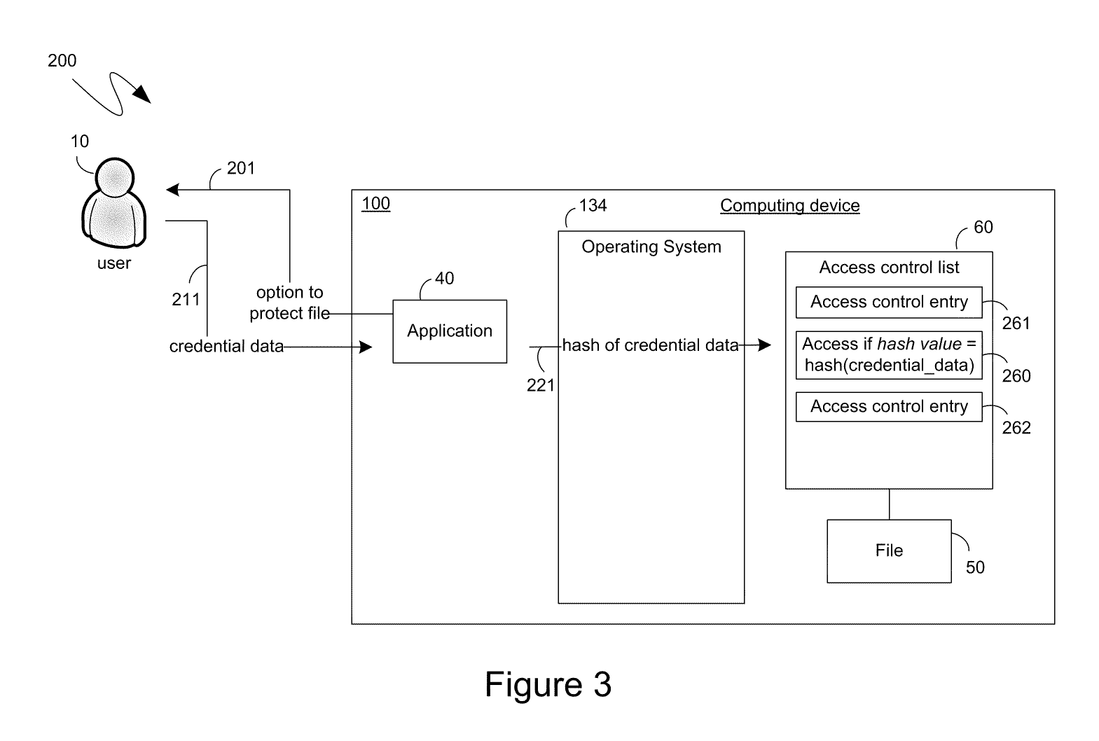

As indicated previously, the operating system 134 of the computing device 100 can implement access control mechanisms that limit the access to particular collections of data based upon information associated with such data, such as, more specifically the access control list 60 shown in FIG. 1. Turning to FIG. 3, the access control list 60 is shown in greater detail, comprising multiple access control entries 260, 261 and 262. Initially, such as shown by the system 200 of FIG. 3, a collection of data, such as the file 50, can be protected by credential data within the context of existing access control mechanisms and methodologies by first providing, such as to the user 10, an option 201 to protect the file 50 with credential data. In the particular example shown by the system 200, the option 201 to protect the file 50 can be provided by an application, such as the application 40. Thus, in one embodiment, the option to protect a file with credential data can be provided by an application associated with such a file. In another embodiment, the option to protect a file with credential data can be provided by an independent application, such as a security utility application program. In yet another embodiment, the option to protect a file with credential data can be provided by the operating system 134 directly.

When the user 10 is provided with an option to protect a file with credential data, such as the option 201, the user 10 can respond to such an option with a provision of the credential data that the user wishes to utilize to limit access to the relevant file, or other collection of data. Thus, as shown in the system 200 of FIG. 3, the user 10 can provide a responsive communication 211 that comprises the credential data the user wishes to utilize to limit access to the file 50. In one embodiment, the option 201 to protect the file 50 can be provided to the user 10 via a user interface, such as a graphical user interface, that could have been displayed to the user via the display device 191 shown in FIG. 2. Similarly, the user's response 211 can be provided via the mouse 181 or keyboard 182 shown in FIG. 2, or other peripherals, such as fingerprint readers, voice analyzers, smartcard readers, or other like peripherals connected to the computing device 100 via the peripheral interface 180, also shown in FIG. 2.

Upon receipt of the credential data contained in the response 211 from the user 10, the receiving application 40 can provide such credential data to the operating system 134, components of which can obfuscate the provided credential data prior to storing it in the access control list 60. Thus, in the exemplary embodiment illustrated by the system 200, the provided credential data can be hashed and stored in the access control list 60 as illustrated by the action 221. In another embodiment, indicated previously, the response 211 from the user 10 can be directed directly to the operating system 134. For example, the operating system 134 can implement a secure communication channel to the user 10, such as through a “secure desktop” or other like user interface or elements thereof. In such an embodiment, the provision of credential data by the user 10, such as via the communication 211, can be directed directly to the operating system 134. The operating system 134 can, then, as before, hash the provided credential data and store it in the access control list 60.

More specifically, as will be known by those skilled in the art, the access control list 60 can comprise individual access control entries, such as the access control entries 260, 261 and 262, that can individually specify one or more criteria by which access to the file 50 can be granted or denied. Traditionally, access control entries, such as the access control entries 261 and 262, comprised a listing of users, or user groups, that were either to be granted specific types of access, such as read access, write access or execute access, to the file 50, or that were to be denied specific types of access to the file 50.

The credential data provided by the user 10 can be added to the access control list 60, such as by the creation of an access control entry 260, that can specify access rights to the file 50 based on a Boolean conditional comprising the credential data. For example, in a simplest case, the credential data provided by the user 10 can be added to the access control list 60 by the creation of access control entry 260 that merely indicates that any user is to be granted access to the file 50 if that user provides the credential data. Alternatively, the access control entry 260 can comprise a multi-element Boolean condition, such as, for example, by specifying that a user is to be granted access to the file 50 only if that user belongs to a predetermined group of users and if that user provides the credential data. In such a case, a user that does not belong to the predetermined group of users, may not even be provided with the opportunity to enter credential data since such a user would not be allowed to access the file 50 anyway.

As will be recognized by those skilled in the art, the credential data can be combined with existing access control requirements in a myriad of ways, including the creation of a new access control entry, such as the access control entry 260, that conditions some type of access to the file 50 based only on the provision of credential data, the modification of existing access control entries, such as the access control entries 261 and 262, wherein the access requirements enumerated by those existing access control entries can be further limited by the requirement of the provision of credential data, or other combinations and permutations thereof.

In one embodiment, because the access control list 60 may be accessible to users that should not be made aware of the credential data, the credential data in the individual access control entries, such as the access control entries 260, 261 and 262, can be specified in an obfuscated form. Thus, for example, as shown in the system 200 of FIG. 3, the credential data provided by the user 10 via the communication 211 can be hashed, such as by the operating system 134 or, more specifically, by mechanisms provided thereby, prior to the creation of, or the modification of, access control entries dependent upon such credential data. In such a case, the access control entries dependent upon such credential data would specify Boolean conditionals based not on the credential data itself, but rather on the obfuscated credential data, such as the resulting hash value. As will be described further below, when checking to verify whether a user is to be granted access to the file 50, the relevant mechanisms can utilize the same obfuscation, such as the same hashing mechanism, to obfuscate the credential data provided by that user seeking to access the file. The obfuscated version of the provided credential data can then be compared to the obfuscated version of the credential data stored in the relevant access control entries in order to determine whether or not the user is to be allowed access to the file.

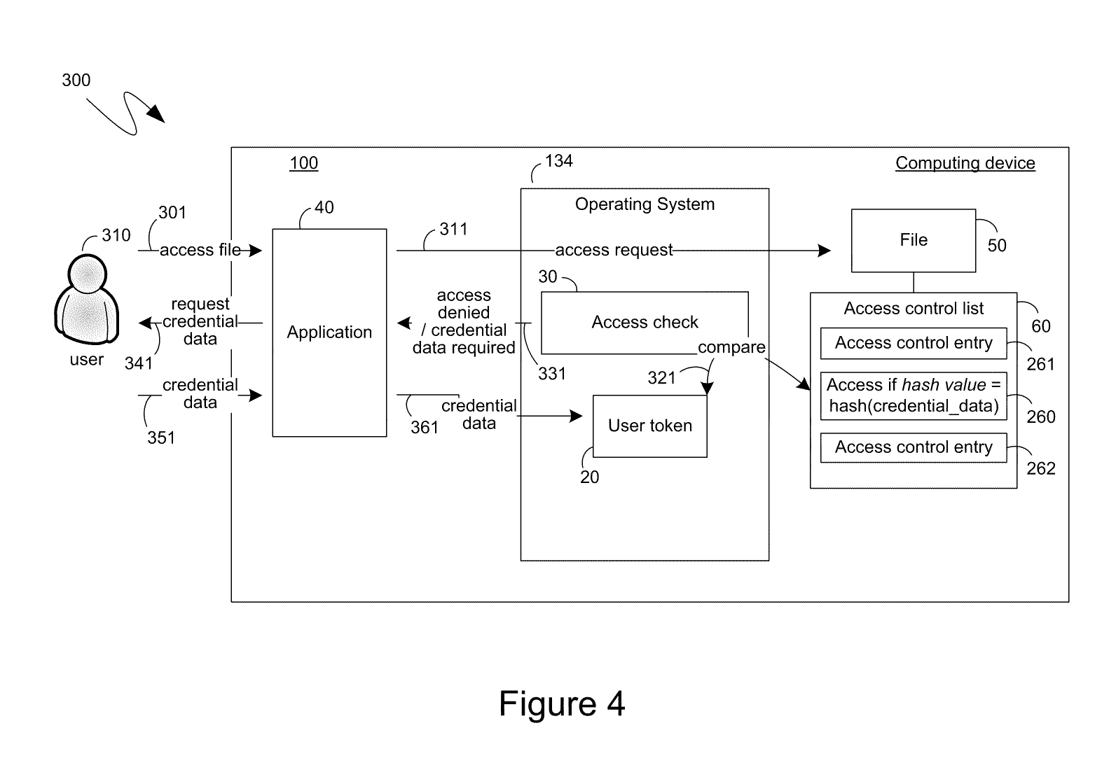

Turning to FIG. 4, the system 300 shown therein illustrates an exemplary series of communications and actions that can be performed when a user, such as the user 310, attempts to access a file, such as the file 50, whose access is controlled by an access control list, such as the access control list 60, having at least one relevant access control entry, such as the access control entry 260, that is based, at least in part, on the provision of credential data by the user 310. As was described in detail above, when a user, such as the user 310, logs on to the computing device 100, or otherwise identifies themselves to the computing device 100, the operating system 134 can create a user token, such as the user token 20. For purposes of illustrating one useful aspect of the described mechanisms, the exemplary system 300 of FIG. 4 illustrates a different user 310 from the user 10 illustrated above, who can utilize the logon information of the user 10 and can, thereby, cause the operating system 134 of the computing device 100 to generate the same user token 20 as that illustrated above. For example, the user 310 shown in FIG. 4 can be a child of the user 10 shown in FIGS. 1 and 3 and can be using their parent's account to logon to the computing device 100. Similarly, the user 310 can be a malicious user that has improperly obtained access to the logon information of the user 10 and has logged on to the computing device 100 as the user 10.

As will be recognized by those skilled in the art, if the same user token 20 is generated when both the user 10 and the user 310 logon to the computing device 100, existing access control mechanisms, such as those implemented by the operating system 134, will not be able to distinguish between the two human users 10 and 310, as they will appear, to such existing access control mechanisms, as the same user, namely the user associated with the user token 20. Thus, information that the user 10 may have wanted to limit only to themselves would not, in fact, be so limited. For example, if the user 10 had specified that the file 50 could only be accessed by that user, such as by providing an access control entry in the access control list 60 associated with the file specifying that only the user 10 was to be allowed access, a user 310, utilizing the same logon credentials as the user 10, would be allowed access to the file 50, since the user token 20, whose information would be compared to the access control list 60 to determine whether or not to grant access to the file 50, would indicate that the user 310 was the same as the user 10. In such a case, parents would not, for example, be able to limit the information accessible to their children using the same account, nor would individuals be able to further protect certain collections of data even from malicious users that may surreptitiously gain access to such individuals' accounts.

The presence, however, of at least one relevant access control entry, such as the access control entry 260, whose access control is based on credential data, can prevent such difficulties. For example, as shown in the system 300 of FIG. 4, even if the user 310 logs on to the computing device 100 as the user 10, causing the operating system 134 of the computing device 100 to generate the same user token 20, the access control mechanisms implemented, such as by the operating system 134, can still prevent the user 310 from accessing the file 50 if the access control list 60 associated with the file 50 comprises at least one relevant access control entry, such as the access control entry 260, whose access control is based on credential data.

More specifically, the user 310 can, initially, attempt to access the file 50, such as by utilizing an application 40, or other relevant process of executing computer-executable instructions. Thus, as shown in the system 300 of FIG. 4, the user 310 can perform an access file action 301 that can cause the application 40 to utilize the operating system 134 to request access of the file 50, as shown by the access request 311. In response to the access request 311, the operating system 134 can utilize the above-described access check mechanisms 30 to verify that the application 40 that is requesting access is associated with a user token 20 that, when compared to the information in the access control list 60, will reveal that access is to be granted to the file 50. In the exemplary embodiment illustrated in the system 300 of FIG. 4, the comparison action 321 undertaken by the access check mechanisms 30 can, for example, find that the user token 20 does not comprise the relevant credential data required to access the file 50, such as specified by the access control entry 260 that was described in detail above.

For purposes of the present illustrative example, it is assumed that the access control entries 261 and 262 comprise information that is not relevant to the user token 20, such as, for example, specifying the access rights of users or user groups that are different from the user identified by the user token 20. By contrast, the access control entry 260 can be relevant to the user token 20, either by specifically enumerating the user identified by the user token 20, either directly or by membership within a group of users, or by enumerating all users, or otherwise not limiting the applicable users. In the former case, the access control entry 260 can require both that the user seeking to access the file 50 be a specific user or a member of specific user groups, and that the user be able to enter the credential data listed in that access control entry. In the latter case, the access control entry 260 can merely require that the user be able to enter the credential data, and that the provision of the correct credential data is sufficient to gain access to the file 50, irrespective of the specific user identified by the user token 20.

Once the access check mechanisms 30 determine that: a relevant access control entry, such as the access control entry 260, exists for the user identified by the user token 20; that the relevant access control entry requires the provision of specific credential data; and that the user token 20 associated with the application 40, which is seeking to access the file 50, does not comprise the specific credential data, the access check mechanisms can return an access denied notification 331 to the application 40. The access denied notification 331 can differ from traditional access denied notifications in that it can further notify the application 40 that the access was denied because credential data was required and was not already part of the user token 20. Compatible applications, such as those that can support interfaces provided by an operating system implementing the above-described mechanisms, can recognize the specific type of access denial notification 331 and can request the required credential data from the user 310, such as by the request 341. In one embodiment, the request 341 can be provided via a user interface of the application 40, or of the operating system 134, such as can be displayed via the display device 191 shown in FIG. 2.

In response to the request 341, the user 310 can provide the credential data to the application 40, such as via the communication 351. As indicated previously, the provision of credential data, such as via the communication 351, can occur via traditional user input devices such as the mouse 181 or keyboard 182 shown in FIG. 2. As also indicated previously, the provision of credential data, such as via the communication 351, can also occur via specialized input devices, such as fingerprint readers, voiceprint scanners, smartcard readers, or other like devices that can be connected to the computing device 100 via the peripheral interface 180 shown in FIG. 2.

The credential data provided by the user 310 via the communication 351 can be provided by the application 40, initially receiving such a communication, to the operating system 134 for storage in the user token 20. A subsequent access attempt, analogous to the access request 311, can then be initiated by the application 40. As in the case of the above-described access request 311, such a subsequent access request (which is not shown in FIG. 4 to maintain legibility) can again trigger a comparison, such as the comparison 321. This subsequent comparison (which, again, is not shown in FIG. 4 to maintain legibility) can reveal that the user token 20 now comprises the credential data called for by the relevant access control entry 260 of the access control list 60 associated with the file 50. As a result, this subsequent access request by the application 40 can result in the granting of access to the file 50 by the operating system 134.

As indicated previously, the information regarding the credential data that can be part of an access control entry, such as the access control entry 260, can be hashed or otherwise obfuscated. Consequently, in comparing the credential data provided by the user 310, such as via the communication 351, and stored in the user token 20, the access check mechanisms 30 can, themselves, hash, or otherwise obfuscate, the credential data of the user token 20 in order to accurately compare it to that indicated in the access control entry 260. In one embodiment, the operating system 134 can utilize predetermined obfuscation mechanisms, such as known, standardized, hashing mechanisms to obfuscate the credential data that is indicated in access control entries, such as the access control entry 260. Subsequently, those same predetermined obfuscation mechanisms can be utilized by the access check mechanisms 30 in obfuscating the credential data stored with the user token 20 in order to perform an accurate comparison. In another embodiment, the credential data stored with the user token 20 can be stored in an already obfuscated form such that the obfuscation applied to the credential data stored in the user token 20 is the same as the obfuscation applied to the credential data as indicated in access control entries, such as the access control entry 260. In such an embodiment, the access check mechanisms 30 need only compare with the raw obfuscated data, such as the raw hash values, to determine whether or not the credential data provided by the user 310, such as via the communication 351, matches that of the relevant access control entry, such as the access control entry 260. In yet another embodiment, the credential data provided by the user 310 can be stored by the operating system 134 in the user token 20 in a protected manner such that the access check mechanisms 30 could first unprotect the credential data and then perform the comparison as described above. For example, the credential data provided by the user 310 can be stored in an encrypted form in the user token 20, encrypted by the operating system using, for example, a public key associated with the access check mechanisms 30, such that the access check mechanisms can then decrypt the encrypted credential data using the access check mechanisms' private key.

In one embodiment, the user token 20 can comprise information, or can be extended to comprise information, stored in a format commonly known as a “name-value pair”. In such an embodiment, the credential data provided by the user 310 can be stored as the “value” associated with an appropriate “name”, such as, for example, the name “passphrase”.

For security purposes, the credential data stored in the user token 20 can be retained for a limited amount of time to prevent the possibility of one user entering credential data and gaining access to a file, such as the file 50, and then having a different user utilize that first user's session on the computing device 100 to gain access to the file 50 inappropriately. For example, in one embodiment, the credential data stored in the user token 20 can be stored only for as long as is necessary to enable the initial access to the file 50. Such an embodiment can be useful where access to the file 50 is traditionally performed only once. Alternatively, if access to the file 50 is performed frequently, such as if the file 50 were a word processing application to which edits are periodically saved as they are entered by the user 310, the necessary credential data can be retained in the user token 20 so long as the file 50 is actively being accessed by the application 40, or, alternatively, so long as the application 40 continues to execute. In yet another alternative embodiment, the credential data stored in the user token 20 can be stored for the duration of a user's session on a computing device, such as the computing device 100. In such an embodiment, however, the user can remember to end their session before granting access to another user, such as the user 310. In the case of shared logons, such as a child sharing a parent's account, a logging-out, followed by a subsequent logging-in by the parent can cause the credential data to no longer be present in the user token 20, thus allowing multiple individuals to share the same account while still maintaining access control based on credentials that only one of them possesses.

In a still further embodiment, to accommodate access inheritance, where child objects inherit their parents' access requirements, the credential data can be retained in the user token 20 while access continues to the parent object. Thus, for example, if the user 310 were to open a folder, where each file in the folder had inherited the folder's requirement that only users having entered the correct credential data be granted access, such credential data could remain with the user token 20 until the folder was closed to avoid prompting the user for the credential data each time the user opened any file within that folder.

In one embodiment, the temporal limitations of the retaining of the credential data in the user token 20 can be enforced by the operating system 134. In such an embodiment, an application providing credential data to the operating system 134 for retention in the user token 20, such as the application 40, can be required to indicate, to the operating system, the length of time that the provided credential data is to be retained in the user token. Alternatively, the operating system 134 can simply retain the provided credential data in the user token 20 for as long as the operating system deems necessary, such as by observing the actions performed by the application 40. In an alternative embodiment, the time limitations of retaining the credential data and the user token 20 can be enforced by the application providing the credential data to the operating system 134, such as the application 40. In such an embodiment, the application, such as the application 40, can be in the best position to know when credential data is no longer required and can be removed from the user token 20.

The application providing credential data to the operating system 134 for retention in the user token 20 can further “time stamp” the provided credential data, such as by associating with the credential data the time when the credential data was provided for inclusion with the user token 20. Such a time stamp can be referenced, by either the operating system 134, or an application, such as the application 40, for determining if the temporal limitations have been exceeded and the credential data should be discarded or otherwise no longer used.

For greater security, though potentially generating inefficiencies on the part of the user 310, the credential data provided by the user can be retained in the user token 20 only long enough to enable the access request associated with the provision of the credential data. In such an embodiment, every subsequent access, irrespective of the duration of the intermission between accesses, can cause a request to the user to re-enter the credential data.

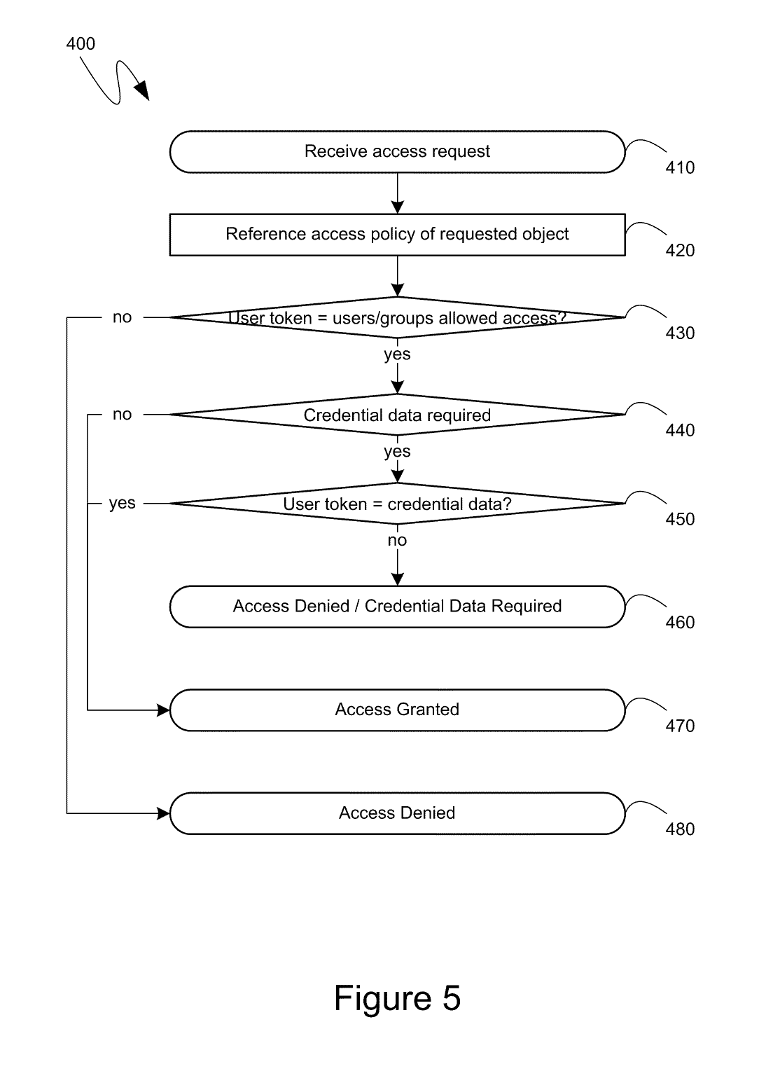

Turning to FIG. 5, the flow diagram 400 shown therein illustrates an exemplary series of steps that can be performed by the operating system 134, and, more specifically, by the access check mechanisms 30, or other associated mechanisms. Initially, at step 410, an access request can be received, such as by the operating system 134, that can trigger the subsequent steps. Subsequently, at step 420, the access policy of the object to which the access request at step 410 was directed, such as the file 50 shown in prior figures and described above, can be referenced. As indicated previously, such an access policy can be in the form of an access control list, such as the access control list 60, comprising one or more access control entries, such as the access control entries 260, 261 and 262, each of which was also shown in prior figures and described above.

At step 430, a determination can be made, based on comparison between the access policy of the requested object and the user token of the user on whose behalf the access request of step 410 was made, whether the user identified in the user token is the same as any of the users, or is in any of the user groups, enumerated by the access policy of the requested object. As indicated previously, some access control entries, such as those that only require the provision of credential data, may, either implicitly or explicitly, be otherwise unbounded as to a particular user or set of users. In such a case, those access control entries can be considered to satisfy the check of step 430. If no access control entries are found that satisfy the check of step 430, processing can proceed to step 480, at which point the computer-executable instructions that requested the access at step 410 can be notified that the access was denied.

If, on the other hand, at least one access control entry is relevant to the user identified by the user token, as determined at step 430, a further determination, at step 440, can be made. More specifically, the determination at step 440 can identify whether credential data is required for the user identified by the user token to access the object whose access was requested at step 410. If no such credential data is required, as determined at step 440, processing can proceed to step 470, at which point the computer-executable instructions that requested the access at step 410 can be granted access. If credential data is, however, required, as determined at step 440, processing can proceed to step 450 at which point the required credential data can be compared to any credential data present in the user token. If the required credential data is, in fact, part of the user token, as determined at step 450, processing can again proceed to step 470, where access can be granted to the requested object.

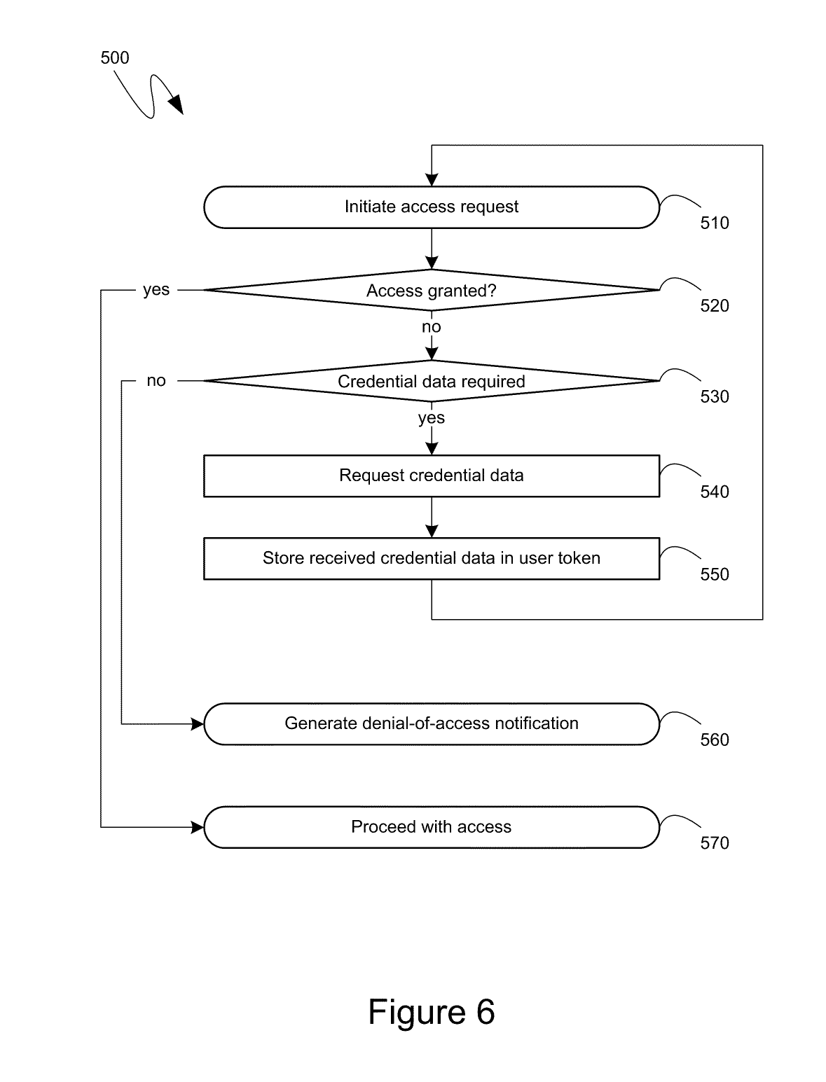

If, however, the user token does not comprise the required credential data, as determined at step 450, processing can proceed to step 460, at which point the computer-executable instructions that requested the access at step 410 can be notified that the access was denied. In addition, as indicated previously, the notification at step 460 can further indicate to the computer-executable instructions requesting access that credential data was required. As described above, and as will be shown with reference the flow diagram 500 of FIG. 6, such computer-executable instructions can utilize the credential data required aspect of the notification provided at step 460 to request the credential data from the user and reattempt the access.

Turning to FIG. 6, the flow diagram 500 shown therein illustrates an exemplary series of steps that can be performed by computer-executable instructions that seek to access data that are compatible with the above described access control mechanisms that are based on the provision of credential data. Initially, at step 510, an access request can be initiated. Such an access request can be the same access request received at step 410 of the flow diagram 400 shown in FIG. 5. Subsequently, a determination can be made, at step 520, to determine whether access was granted. If it is determined, at step 520, that access was granted, such as would have occurred at step 470 of the flow diagram 400 shown in FIG. 5, then processing can proceed, at step 570, to access the object to which the access request 510 was directed. If, however, it is determined, at step 520, that access was not granted, processing can proceed to step 530. A determination, at step 520, that access was not granted can be based on either a denial of access, such as would have been made as part of step 480 of the flow diagram 400 of FIG. 5, or based on a denial of access due to the lack of appropriate credential data, as would have been indicated as part of step 460 of the flow diagram 400 of FIG. 5.

If, at step 520, it is determined that access was not granted, processing can proceed to step 530, at which point a determination can be made as to whether credential data was required, such as, for example, would have been indicated as part of step 460 of the flow diagram 400 of FIG. 5. If, at step 530, it is determined the credential data was not required, then the denial of access, such as would have been made as part of step 480 of the flow diagram 400 of FIG. 5, can be communicated to the user, or other appropriate access-initiating process, at step 560. Alternatively, if, at step 530, it is determined that credential data is required, processing can proceed to step 540 wherein such credential data can be requested of the user, or other appropriate access-initiating process. Whatever credential data is provided in response to the request at step 540 can be subsequently stored in the user token at step 550. More specifically, as will be known by those skilled in the art, at step 550, the received credential data can be, in turn, provided to the operating system, or other relevant process, to store the credential data in the user token. Processing can then return to step 510, at which point another access request can be initiated.

If the credential data provided in response to step 540, and stored in the user token at step 550, was appropriate for the object being accessed, the subsequent access request at step 510 can result in access being granted, as determined at step 520, thereby enabling access to proceed, as shown in step 570.

As can be seen from the above descriptions, mechanisms for extending existing access control to now provide access control based on, at least in part, the provision of credential data have been enumerated. In view of the many possible variations of the subject matter described herein, we claim as our invention all such embodiments as may come within the scope of the following claims and equivalents thereto.

We claim:

1. One or more computer-readable media comprising computer-executable instructions for controlling access to a set of data that is associated with an access control list comprising one or more access control entries, the computer-executable instructions performing steps comprising:
receiving, from accessing computer-executable instructions, a request to access the set of data;
searching the one or more access control entries for one or more access control entries relevant to a user identified by a user token associated with the accessing computer-executable instructions;
comparing credential data associated with the user token to credential data specified by the one or more access control entries relevant to the user if the one or more access control entries relevant to the user specify credential data; and
denying the request and notifying the accessing computer-executable instructions that credential data is required to access the set of data if the comparing reveals that the credential data associated with the user token differs from the credential data specified by the one or more access control entries relevant to the user.

2. The computer-readable media of claim 1, wherein the computer-executable instructions for comparing comprise computer-executable instructions for obfuscating the credential data associated with the user token using an equivalent obfuscation mechanism to that utilized to obfuscate the credential data specified by the one or more access control entries relevant to the user.

3. The computer-readable media of claim 1, wherein the computer-executable instructions for comparing comprise computer-executable instructions for decrypting the credential data associated with the user token.

4. The computer-readable media of claim 1, wherein the one or more access control entries relevant to the user comprise a Boolean conditional statement comprising at least one conditional reference to the credential data.

5. The computer-readable media of claim 1 comprising further computer-executable instructions performing steps comprising: receiving the credential data and generating at least one of the one or more access control entries relevant to the user so as to specify that access to the set of data is to be granted if the received credential data is associated with the user token that is associated with the accessing computer-executable instructions when the request to access the set of data is received.

6. The computer-readable media of claim 5, wherein the computer-executable instructions for generating the at least one of the one or more access control entries comprise computer-executable instructions for enumerating a set of users in the generated at least one of the one or more access control entries such that the generated at least one of the one or more access control entries specifies that the access to the set of data is to be granted if both the received credential data is associated with the user token that is associated with the accessing computer-executable instructions and the user identified by the user token that is associated with the accessing computer-executable instructions is among the enumerated set of users.

7. One or more computer-readable media comprising computer-executable instructions that access a set of data that is associated with an access control list comprising one or more access control entries, the computer-executable instructions performing steps comprising:
requesting access to the set of data;
receiving, in response to the requesting the access, a denial of access notification comprising an indication that credential data is required to access the set of data;
requesting, in response to the receiving the denial of access notification, the credential data;
receiving a received credential data in response to the requesting the credential data;
associating, for a temporally limited amount of time, the received credential data with a user token associated with the computer-executable instructions; and
requesting, for a subsequent time, access to the set of data;
wherein the temporally limited amount of time is only so long as to enable accesses that are associated with the requested access and the subsequently requested access to proceed.

8. The computer-readable media of claim 7, wherein the computer-executable instructions for requesting the credential data comprise computer-executable instructions for requesting the credential data from a user by prompting the user.

9. The computer-readable media of claim 7, wherein the computer-executable instructions for associating the received credential data with the user token comprise computer-executable instructions for obfuscating the received credential data prior to the associating, the obfuscating using an equivalent obfuscation mechanism to that utilized to obfuscate credential data specified by one or more access control entries relevant to a user associated with the user token.

10. The computer-readable media of claim 7, wherein the computer-executable instructions for associating the received credential data with the user token comprise computer-executable instructions for encrypting the received credential data prior to the associating so that access control mechanisms can decrypt the encrypted received credential data.

11. The computer-readable media of claim 7, wherein the computer-executable instructions for associating the received credential data with the user token comprise computer-executable instructions for generating a time stamp; and wherein further the temporally limited amount of time is enforced by an operating system responsible for the user token.

12. The computer-readable media of claim 7, wherein the accesses that are enabled by the temporally limited amount of time comprise a single editing session of the set of data by the computer-executable instructions.

13. The computer-readable media of claim 7, wherein the accesses that are enabled by the temporally limited amount of time comprise accesses directed to one or more child objects of the set of data.

14. The computer-readable media of claim 7, wherein the accesses that are enabled by the temporally limited amount of time consist of only the subsequently requested access.

15. A method of accessing a first set of data that is associated with an access control list comprising one or more access control entries, the method comprising the steps of:
requesting access to the set of data;
searching the one or more access control entries for one or more access control entries relevant to a user identified by a user token associated with the requesting the access;
comparing credential data associated with the user token to credential data specified by the one or more access control entries relevant to the user if the one or more access control entries relevant to the user specify credential data;
generating a denial of access notification comprising an indication that credential data is required to access the set of data if the comparing reveals that the credential data associated with the user token differs from the credential data specified by the one or more access control entries relevant to the user;
requesting, in response to receiving the denial of access notification, the credential data;
receiving a received credential data in response to the requesting the credential data;
associating, for a temporally limited amount of time, the received credential data with the user token; and
requesting, for a subsequent time, access to the set of data;
wherein the temporally limited amount of time is only so long as to enable accesses that are associated with the requested access and the subsequently requested access to proceed.

16. The method of claim 15, wherein the comparing comprises obfuscating the credential data associated with the user token using an equivalent obfuscation mechanism to that utilized to obfuscate the credential data specified by the one or more access control entries relevant to the user.

17. The method of claim 15, wherein the one or more access control entries relevant to the user comprise a Boolean conditional statement comprising at least one conditional reference to the credential data.

18. The method of claim 15, further comprising the steps of: initially receiving an initial credential data; and generating at least one of the one or more access control entries relevant to the user so as to specify that access to the set of data is to be granted if the initial credential data is associated with the user token that is associated with the requesting the access when the requesting the access occurs.

19. The method of claim 15, wherein the accesses that are enabled by the temporally limited amount of time comprise accesses directed to one or more child objects of the set of data.

20. The method of claim 15, wherein the accesses that are enabled by the temporally limited amount of time consist of only the subsequently requested access.
